(19) United States
(12) Patent Application Publication
(10) Pub. No.: US 2009/0293490 A1
(43) Pub. Date: Dec. 3, 2009

(54) Combustor wall with improved cooling

(75) Inventor: Emmanuel V.J. Aurifeille, Derby (GB)

Correspondence Address: OLIFF & BERRIDGE, PLC, P.O. BOX 320850, ALEXANDRIA, VA, 22320-4850, US

(73) Assignee: ROLLS-ROYCE PLC, LONDON (GB)

(21) Appl. No.: 12/385,870

(22) Filed: Apr. 22, 2009

(30) Foreign Application Priority Data
May 28, 2008 (GB) 0809546.5

(51) Int. Cl. F23R 3/42; F02C 7/12

(52) U.S. Cl. 60/753

(57) ABSTRACT

A combustor for a turbine engine has a cooling ring. The cooling ring has an internal corner that is shaped to cause a flow of hot or fuel rich gas flowing over the wall to separate from the wall. The efficiency of the cooling ring is improved.

This invention relates to combustors for turbine engines and in particular a cooling arrangement for a turbine engine combustor.

A gas turbine engine relies on highly effective cooling to maintain safety and efficiency of the engine. For the hot parts of the engine, typically the combustor and turbines, the cooling is provided by a flow of air taken, in the cases of aero gas turbines, from an overall flow of air through the core of the engine that could otherwise be used to provide thrust or improve the overall efficiency of the engine.

The products of the combustion reaction which takes place in the combustor are hundreds of degrees hotter than the melting temperature of the metal which forms the combustor wall. A combustor wall can have a double skin where an outer skin is protected from direct contact with the products of combustion by an inner wall that is often formed from a plurality of heat resistant tiles. In a further arrangement the wall has a single skin of a metal wall having an optional, but preferable, thermal barrier coating.

A combustor has a series of steps, called cooling rings, along its axial length through which cooler air is admitted to the combustor to form a film to protect the walls from hot combustion gasses and which can be formed either through shaping, machining or by welding several sections of the combustor together. The steps provide an increase to the combustor cross-sectional area and accordingly step outwards from the combustor centre-line. For an annular combustor the centre line is taken to be a line, parallel with the engine centre-line and midway between the radial inner and radial outer walls of the combustor.

There are two types of cooling ring with subtle but important distinctions between them. The first is commonly called a skirted ring and is heavier, more difficult to manufacture and costly than the other type that is commonly known as a skirt-less.

A skirted cooling ring is made from a thicker combustor wall locally machined to leave thicker sections at the outward step. The thicker sections mean a combustor may be heavier than desired. Alternative skirted cooling rings are formed by two or more sections welded together to form the desired profile. A skirted cooling ring has a single circumferentially extending array of relatively large holes protected by an elongate skirt that extends circumferentially around the combustor and protects a flow of air through the holes to give it sufficient time to form a uniform, circumferential, film. The wall must be thick at the location of the holes as the stress on the combustor from the larger holes requires mitigation.

The elongate skirt is difficult to form and is typically attached by welding or by significant machining of the internal wall of the combustor. Welding is difficult because of having to align the skirt with the combustor step and then having to form a robust and accurate weld. Machining is difficult because of the long skirt and the volume of material that has to be removed.

Significant cooling effort is required to protect the skirt which can fail because of the high temperatures in the combustor. The skirt fails when it burns away to give little protection to the flow of air through the array of apertures. In this situation the film is incomplete and the outer wall is liable to damage and can quickly fail due to contact with the hot gases.

The alternative structure is known as a skirt-less ring. The arrangement is formed by machining or possibly from a series of sections, of sheet of metal pressed to the required profile. The profile typically has plurality of axial sections where the wall extends generally axially from the front to the rear of the combustor and, between adjacent axial portions, an outward step that extends generally radially from the centreline of the combustor. In this arrangement the wall follows a defined contour and two or more staggered rows of apertures are provided in the outward step. The apertures are smaller than the apertures in the skirted cooling ring construction permitting the thinner wall to be used. Care must still be taken in designing the wall to ensure that stress cracking is avoided since a crack can quickly propagate across the holes causing an unzipping of the combustor.

Existing skirt-less ring designs do not always offer good cooling effectiveness. As the holes feed air into the combustor as a plurality of discrete jets it is normal for hot or fuel-rich streams of gas from the main flow through the combustor to become entrained in the cooling film. When a hot stream is entrained in the cooling film the efficiency of the film is degraded and thus a greater flow is required to achieve the same level of cooling thereby reducing the efficiency of the combustor. When fuel is entrained in the cooling film it can, when mixed with the air in the cooling flow, provide an adequate fuel-air ratio for combustion to occur within the cooling film itself. The cooling film eventually degrades and requires replenishment from another source. The degree to which a hot or fuel rich stream is entrained within the cooling film accelerates the degradation of the cooling film.

It has also been found that hot combustion gases can remain attached to the outward step which can increase the temperature of the wall beyond its material capability and the life of the combustor flame tube is reduced.

It is an object of the present invention to seek to provide an improved combustor.

According to a first aspect of the invention there is provided a combustor wall for a turbine engine, the combustor wall extending about a combustor axis and bounding a combustion volume and having a first region where the wall extends generally axially continuing into a second region where the wall extends relatively radially, wherein the second region of the wall has a plurality of radially spaced arrays of apertures, wherein in use a gas flow within the combustion volume flows across the first portion towards a corner between the first region and the second region, the wall being characterised in that the angle of the corner between the first and second portions is between 60° and 90° and causes the flow of gas to separate from the wall.

Preferably the first portion extends axially downstream of at least part of the second region.

Preferably the first portion extends axially downstream of the part of the second region by between 0.5 and 2 mm.

The portion which extends axially downstream may comprise a build-up of material.

The build-up material may be a thermally resistant ceramic.

Embodiments of the invention will now be described by way of example only, with reference to the accompanying drawings, in which:

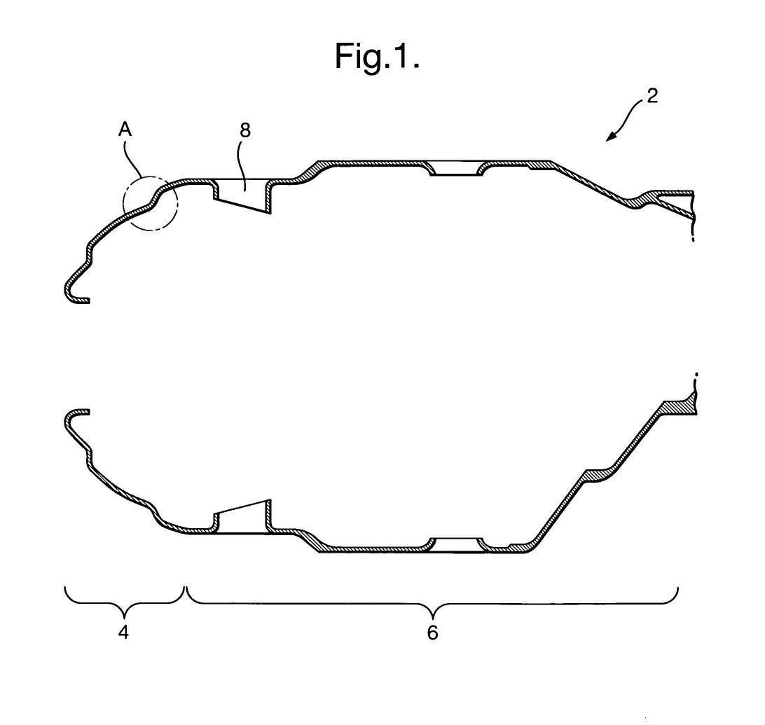

FIG. 1 depicts a combustor having a plurality of cooling rings.

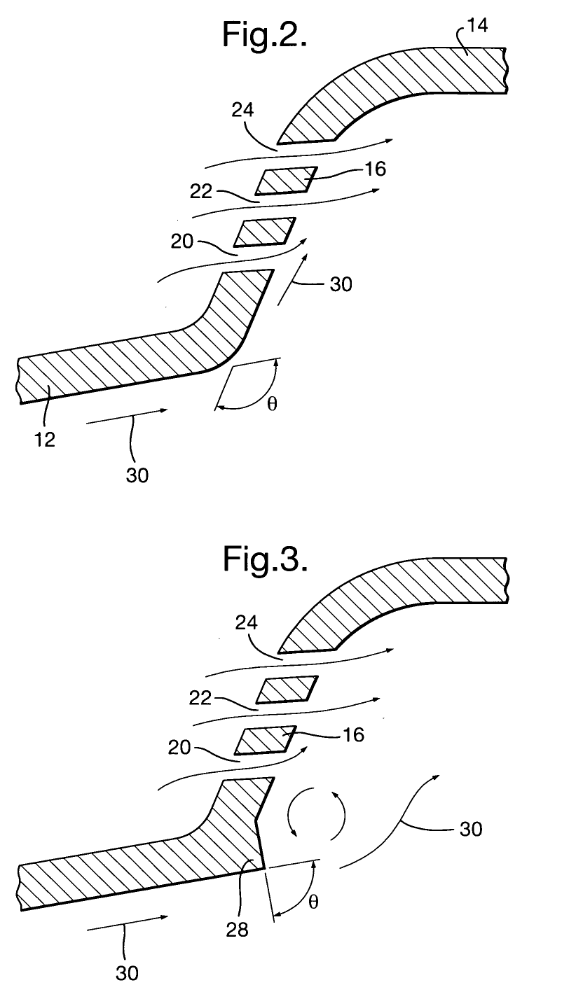

FIG. 2 depicts a portion of a conventional combustor wall equivalent to an expanded view of zone “A” of FIG. 1

FIG. 3 depicts a portion of a combustor wall equivalent to an expanded view of zone “A” of FIG. 1 in accordance with the invention

FIG. 1 depicts a combustor 2 having a plurality of cooling rings. The combustor is formed in two sections with the upstream, or head, portion 4 being provided with pressed z-rings and a downstream, or main, portion 6 being formed with skirt-less machined cooling rings.

The combustor has a number of dilution ports 8 which supply dilution air into the combustor.

FIG. 2 depicts an enlarged view of area A of FIG. 1 for a conventional combustor z-ring and should be used in comparison with FIG. 3 depicting an enlarged view of a skirt-less ring in accordance with the invention.

The combustor head wall of the embodiment is formed of a machined sheet of nickel alloy though it will be appreciated that other metals, alloy or materials may be used if structurally and thermally suitable. Similarly the wall may be pressed into shape. The cooling ring has a first generally axial portion 12, a second generally axial portion 14 and a generally radial portion 16 connecting the two. A number of radially spaced circumferential arrays 20, 22, 24 of apertures are located in the generally radial portion 16 of the cooling ring.

Combustion air flow over the radially inner surface of the first axial portion is relatively fuel rich. The flow remains attached to the wall as it goes round the corner and is entrained in the airflow coming through the cooling holes 20, 22, 24. As the holes feed air into the combustor as a plurality of discrete jets the fuel-rich streams of gas, when mixed with the air in the cooling flow, can provide an adequate fuel-air ratio for combustion to occur within the cooling film itself.

It has also been found that hot combustion gases can also be entrained within the cooling film or remain attached to the outward step which can increase the temperature of the wall beyond its material capability and the life of the combustor flame tube is reduced.

FIG. 3 depicts an enlarged view of area A of FIG. 1 for a combustor cooling ring in accordance with the invention. The corner between the first axial portion and the radial portion is provided with a circumferential corner 28 that extends axially forward of a portion of the radial wall. The forward axial distance of the corner is less than 2 mm, though it will be appreciated that this may vary depending on size or type of the combustor used. The corner 28 causes the fuel rich and hot gas stream 30 to separate from the radial portion of the wall 16 to delay its interaction with the cooling air flowing through the apertures. This delay gives the flow of air through the plurality of apertures time to become more circumferentially uniform which increases its capacity to block the hotter or richer fuel/air from reaching the radial or second axial portion of the wall.

Where the combustion gas is too rich to burn effectively and is likely to become entrained in the cooling air and create combustion in the cooling film, the corner moves the combustion region away from the wall without significantly delaying combustion. Accordingly, the peak combustion temperature can still be reached at an early stage whilst having a beneficial effect on the cooling efficiency of the cooling ring.

The desired angle of internal corner is dependent on the momentum of the flow within the combustor but in the cooling ring of the invention the angle θ of the internal corner has and angle that is typically up to and including 90°.

One of the further benefits of the construction is that even if the corner is damaged in some way e.g. thermally, the cooling-ring will still operate as a conventional ring.

It is often desirable to coat the internal surface of the combustor and the cooling rings with a thermal barrier coating. Advantageously, it is possible to build up the corner using a thicker coating of TBC selectively deposited at the desired location of the cooling ring. Alternatively, the areas that need to be thinner can be masked to prevent such a large build-up of coating at those areas.

The invention is applicable to all types of combustors having cooling rings, including annular combustors or turbo-annular combustors for example.

I claim:

1. A combustor wall for a turbine engine, the combustor wall extending about a combustor axis and bounding a combustion volume and having a first region where the wall extends generally axially continuing into a second region where the wall extends relatively radially, wherein the second region of the wall has a plurality of radially spaced arrays of apertures, wherein in use a gas flow within the combustion volume flows across the first portion towards a corner between the first region and the second region, the wall being characterised in that the angle of the corner between the first and second portions is between 60° and 90° and causes the flow of gas to separate from the wall.

2. A combustor wall according to claim 1, wherein the first portion extends downstream of at least part of the second region.

3. A combustor wall according to claim 2, wherein the first portion extends downstream of the part of the second region by between 0.5 and 2 mm.

4. A combustor wall according to claim 2, wherein the portion which extends downstream comprises a build-up of material.

5. A combustor wall according to claim 4, wherein the build-up material is a thermally resistant ceramic.
